(19) United States
(12) Patent Application Publication
(10) Pub. No.: US 2008/0286568 A1
(43) Pub. Date: Nov. 20, 2008

(54) HEAT-REFLECTING ADHESIVE TAPE HAVING HIGH ABRASION PROTECTION

(75) Inventors: Patrik Kopf, Hamburg (DE); Ronald Pfaff, Hamburg (DE); Heike Moller, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: tesa AG, Hamburg (DE)

(21) Appl. No.: 12/112,073

(22) Filed: Apr. 30, 2008

(30) Foreign Application Priority Data
May 4, 2007 (DE) 10 2007 021 505.5

(51) Int. Cl. B32B 7/12; B65H 81/00

(52) U.S. Cl. 428/336; 156/184

(57) ABSTRACT

Heat-reflecting adhesive tape, preferably for wrapping elongate material such as, more particularly, leads or cable harnesses, having a tapelike backing composed of an assembly comprising at least one first layer, formed by a glass fabric having a basis weight of 30 to 200 g/m², and at least one second layer, formed by a metallic layer having a thickness of 10 to 40 μm and a thermal effectiveness to SAE J2302 at 350° C. of greater than 45° C., having a pressure-sensitive adhesive coating applied at least to one side of the backing, and at least one stripe of a covering which is provided on the free side of the adhesive coating and which extend(s) in the longitudinal direction of the adhesive tape and which cover(s) between 20% and 90% of the adhesive coating.

The invention relates to a heat-reflecting adhesive tape having high abrasion protection, preferably for wrapping elongate material such as, more particularly, leads or cable harnesses, having a tapelike backing composed of an assembly comprising at least one first layer, formed by a glass fabric, and at least one second layer, formed by a metallic layer, and having a pressure-sensitive adhesive coating applied at least to one side of the backing. The invention further relates to the use of the adhesive tape and also to a cable loom jacketed with the adhesive tape of the invention.

In numerous sectors of industry, bundles composed of a multiplicity of electrical leads are wrapped, either before installation or when already mounted, in order to reduce the space taken up by the bundle of leads, by means of bandaging, and also to obtain protective functions. With sheet adhesive tapes a certain protection against ingress of liquid is achieved; with airy and bulky adhesive tapes based on thick nonwovens or foam backings, damping properties are obtained; and when stable, abrasion-resistant backing materials are used, a protective function against scuffing and rubbing is achieved. Protection against radiant heat, however, is not offered by such adhesive tapes.

In order to demonstrate a material of construction's compliance with the existing requirements for electrical leads and other components for cable harnesses, a variety of checks and tests are prescribed, and have been summarized in forms which include a works standard agreed between different car makers (LV112—low-voltage leads for motor vehicles, June 2004 version). According to this standard, the material of construction used for insulating the leads shall meet the requirements of VDA 231-106. The minimum and maximum sustained use temperatures (T_{U} and T_{O}) for an exposure time of 3000 h are −40° C. and 100° C. for classification into temperature class B, for example, the material having to withstand a short-term temperature (240 hours) of 125±3° C. and an overload temperature (6 hours) of 150±3° C.

For the purpose of specifying their maximum sustained use temperature, electrical leads and other components for cable harnesses are divided into temperature classes. This division into temperature classes is general knowledge and is shown once again in codified form in the following table:

| | Sustained use | | Temperature for |
|---|---|---|---|
| | temperature | Short-term temperature | thermal overload |
| Class | Tᵤ to Tₒ in ° C. | (Tₒ + 25)° C. | (Tₒ + 50)° C. |
| A | −40 to 85 | 110 ± 2 | 135 ± 3 |
| B | −40 to 100 | 115 ± 3 | 150 ± 3 |
| C | −40 to 125 | 150 ± 3 | 175 ± 3 |
| D | −40 to 150 | 175 ± 3 | 200 ± 3 |
| E | −40 to 175 | 200 ± 3 | 225 ± 3 |
| F | −40 to 200 | 225 ± 4 | 250 ± 4 |
| G | −40 to 225 | 250 ± 4 | 275 ± 4 |
| H | −40 to 250 | 275 ± 4 | 300 ± 4 |

Protection against radiant heat is generally accomplished by means of insulating layers having a low thermal conductivity. In the case of cable harnesses, this end is frequently served by recourse to temperature-resistant sleeves such as convoluted tubes, silicone hoses or metal-armored glass fabric hoses, which, however, do not afford adequate protection for relatively high loads.

For specialty applications there also exist what are known as heat reflection tapes, which are adhesive tapes of the type specified at the outset. These tapes are composed of a glass fiber fabric (second backing layer) which is laminated with an aluminium foil (first backing layer) and provided on the reverse with a highly temperature-resistant silicone adhesive. Products of this kind are offered, for example, by the companies Tyco and Aremco, New York. Disadvantages of these tape products, however, include the high rigidity of the backing and also the high price as compared with conventional adhesive tapes.

EP 1 615 238 A1 discloses a thermally insulating adhesive tape for the wrapping of elongate material such as, more particularly, leads or cable harnesses, which has a tapelike backing. The backing is composed of an assembly of at least one first layer and at least one second layer, the first layer being a metallic layer. On one side of the backing a pressure-sensitive adhesive coating is applied. The second layer of the backing is formed by a polymeric film which is resistant up to a temperature of at least 175° C. or by a textile backing material which is resistant up to a temperature of at least 175° C.

Adhesive tapes of this kind, also called heat reflective adhesive tapes, are known. Since for the thermal reflection effect the adhesive tapes are wrapped with an overlap around cables, for example, the rigidity of the known adhesive tapes, which is attributable more particularly to the thick metal layers used, has a particularly negative effect. Moreover, the unwind force of the adhesive tapes is high, resulting in an increased wrapping pressure, and the cable harness becomes particularly inflexible and exhibits disadvantageous properties for transit and installation. The slower wrapping operation that is a result of this leads to higher costs.

Additionally there are aluminized or aluminium-clad braided hoses known (from Bentley Harris, for example), but in application these hoses again produce a cable harness of very low flexibility (see U.S. Pat. No. 5,843,542 A1 or U.S. Pat. No. 5,849,379 A1). The protection of cables with usually preformed specialty products of this kind proves not to be economic, since the costs for the aforementioned heat protection measures are higher than if leads and components were to be used which satisfy the requirements per se even without such protective measures.

Nor is the use of the thermally insulating, spirally wound adhesive tapes an adequate solution, because winding produces cable harnesses with a low flexibility. As a result there are difficulties associated with transport, and in the course of packaging there is damage to the heat-reflecting metal layer. The subsequent installation of the cable harness and its bending into the necessary shapes are made more difficult by the lack of flexibility. Possible damage to the functional capacity of the cable harness even during these operations, however, must absolutely be avoided.

The abrasion resistance is a measure of the scuff resistance of adhesive tapes. An established method of determining the abrasion resistance of protection systems in vehicle electrics is the international standard ISO 6722, section 9.3 “Scrape abrasion test” (April 2002 version). In this test the test specimen (for example the insulated copper lead or else the wrapping tape adhered to a metal mandrel) is exposed to a thin steel wire under a defined weight load and with defined stroke geometries until the protective casing has been rubbed through and, as a result of a short circuit, the counter which runs at the same time comes to a stop.

Unless indicated otherwise, all details relating to abrasion resistance refer to this ISO 6722 method. For that purpose the adhesive tape is adhered in a single ply in the longitudinal direction on a metal mandrel 10 mm in diameter; the scraping motion takes place centrally on the adhesive tape under a weight load of 7 N. The rubbing body used is a steel wire complying with ISO 8458-2, of 0.45 mm in diameter. The parameter for the abrasion resistance is the number of strokes until short-circuiting occurs. In cases of very high scuff resistance, the mass that is applied can be increased in order to reduce the measurement time and the number of strokes. In this case an applied weight of 10 N has proved to be favorable.

The sound damping effect is a measure of the sound-reducing effect of adhesive tapes. The physical measurement of the sound damping effect is made in accordance with the method described in detail in DE 100 39 982 A1. This is a measurement methodology which is established in the automotive industry, and, for example, is also specified in the BMW standard GS 95008-3 (May 2000 version).

The measurement method according to the BMW standard GS 95008-3 from May 2000 is set out comprehensively below in conjunction with FIGS. 1 and 2.

### BRIEF DESCRIPTION OF THE DRAWINGS

FIG. 1 shows the construction of the measuring apparatus in side elevation, and

FIG. 2 shows the same construction in horizontal elevation.

FIG. 3a shows the adhesive tape of the invention in a first advantageous embodiment in side-on section;

FIG. 3b shows the adhesive tape of the invention in a second advantageous embodiment in side-on section;

FIG. 3c shows the adhesive tape of the invention in a third advantageous embodiment in side-on section;

FIG. 4 shows the use of the adhesive tape of the invention in another embodiment in association with the jacketing of cables, or a cable loom.

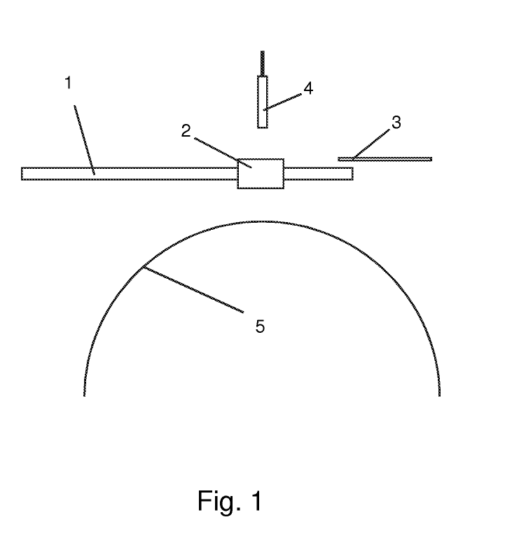

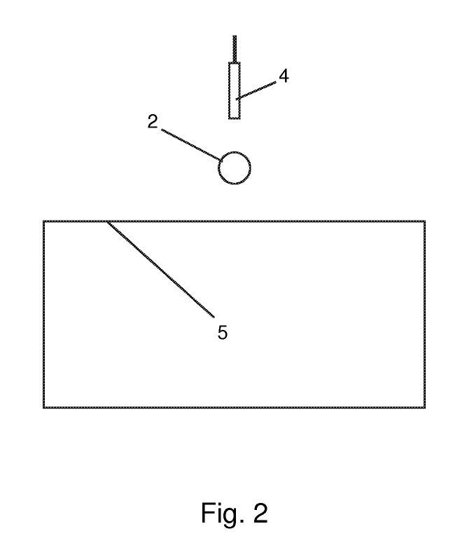

In this measurement method a defined steel rod (1) with a diameter of 8 mm is wrapped with the test specimen (2)—that is, adhesive tape—so as to produce lever lengths of 220 mm and 150 mm. The wrapped steel rod (1) is taken up to the stop (3), to the height of drop, and is dropped with a weight of approximately 16 g onto an aluminium panel (5). The aluminium panel (5), which in the unreformed state measures 350×190×0.3 [mm], is arranged in the form of a half-barrel under the test specimen (2), so as to give an extent of 290 mm. The overall noise outcome is detected and recorded by means of a microphone (4), located over the test setup, in a frequency range of, for example, 20 to 12 500 Hz, using a commercial sound meter, for example of type 2226 from Bruel & Kjaer. Particularly relevant for the human ear are frequencies in the range from 2000 to 5000 Hz. The damping is reported as the difference between the blank value, with the unwrapped steel rod, and the respective measurement value, in dB(A).

As well as the stated measurement methods, the adhesive tapes, in accordance with the automotive testing directive LV 312, are divided into abrasion classes (class A, of low abrasion resistance, to class E, the highest abrasion resistance) and also into sound damping classes (class A, of low sound damping, to class E, the highest sound damping, measured in dB(A)).

The following table offers an overview of the class division described:

| | | Number of strokes | dB(A) damping |
|---|---|---|---|
| Class | Grading | requirement | requirement |
| A | none/slight | <100 | 0 to <2 |
| B | slight | 100 to 499 | >2 to <5 |
| C | moderate | 500 to 999 | >5 to <10 |
| D | high | 1000 to 4999 | >10 to <15 |
| E | very high | >5000 | >15 |

It is an object of the invention to provide a heat-reflecting adhesive tape which when used to jacket cables, for example, not only provides the high level of heat reflection but at the same time also ensures a wrapped product, i.e. in particular a cable loom, which is more flexible than the existing products wrapped with the known adhesive tapes and at the same time offers increased abrasion protection.

This object is achieved by means of an adhesive tape as described hereinbelow. Further embraced by the concept of the invention are the use of the adhesive tape of the invention, and also a cable loom jacketed with the adhesive tape.

The invention accordingly provides a heat-reflecting adhesive tape, preferably for wrapping elongate material such as, more particularly, leads or cable harnesses, having a tapelike backing composed of an assembly comprising at least one first layer, formed by a glass fabric having a basis weight of 30 to 200 g/m², and at least one second layer, formed by a metallic layer having a thickness of 10 to 40 μm and a thermal effectiveness to SAE J2302 at 350° C. of greater than 45° C., and having a pressure-sensitive adhesive coating applied at least to one side of the backing. On the free side of the adhesive coating at least one stripe of a covering is provided, which extend(s) in the longitudinal direction of the adhesive tape and which cover(s) between 20% and 90% of the adhesive coating.

For the purposes of this invention the general expression adhesive tape encompasses all sheetlike structures such as two-dimensionally extended films or film sections, tapes with extended length and limited width, tape sections, diecuts, labels and the like.

According to one advantageous embodiment of the invention the adhesive coating is applied to the open side, opposite the second layer, of the first layer.

With further preference siliconization, at with particular preference 0.5 g/m² to 1.5 g/m², with very particular preference 1 g/m², is applied to the open side, opposite the first layer, of the second layer, this siliconization more particularly being of polysiloxane. This coating of silicone release varnish permits very easy and uniform unwinding of the adhesive tape of the invention in use. As a result, the advantage is produced that it is possible to forego the use of a release paper or release film. Suitable coatings include the typical polysiloxane release varnish coating, for example from Wacker, Rhodia or Dow Corning. Solvent-based, emulsion-based or 100%-system coatings are suitable. These polysiloxane coatings are crosslinked typically through an addition reaction or through a condensation reaction. It is advantageous to use a polysiloxane system with very easy release for the coating.

According to an advantageous embodiment of the invention, the flexural rigidity of the backing and hence of the adhesive tape in longitudinal and transverse direction is less than 500 mN, preferably less than 300 mN (likewise as measured with a Softometer KWS basic 2000 mN from Wolf).

The flexural rigidity of the backing and hence of the adhesive tape, according to a further advantageous embodiment of the invention, is less than 230 mN in the longitudinal direction and less than 150 mN in the transverse direction (likewise as measured with a Softometer KWS basic 2000 mN from Wolf).

According to one preferred embodiment of the invention precisely one stripe of the covering is present on the adhesive coating.

The position of the stripe on the adhesive coating is freely selectable, with an arrangement directly at one of the longitudinal edges of the backing being preferred. In this way an adhesive stripe is produced which extends in the longitudinal direction of the adhesive tape and finishes at the other longitudinal edge of the backing. Where the adhesive tape is used to wrap a cable loom, by guiding the adhesive tape in a spiral movement around the cable loom, the jacketing of the cable loom can be accomplished by adhering the adhesive of the adhesive tape only to the adhesive tape itself, whereas the article does not come into contact with any adhesive. The cable loom wrapped in this way enjoys very high flexibility as a result of the absence of the fixing of the cable by any adhesive. Consequently its flexibility on installation—particularly in narrow passages or sharp bends—is significantly increased.

If a certain level of fixing of the adhesive tape to the article is desired, the wrapping can be accomplished by adhering part of the adhesive stripe to the adhesive tape itself and another part to the article.

According to another advantageous embodiment the stripe is applied centrally on the adhesive coating, thereby producing two adhesive stripes extending on the longitudinal edges of the backing in the longitudinal direction of the adhesive tape. For the secure and economic application of the adhesive tape in the said spiral movement around the cable loom, and to counter the slipping of the resulting protective jacketing, the two adhesive stripes each present on the longitudinal edges of the adhesive tape are advantageous, particularly if one, which is usually narrower than the second stripe, serves as a fixing aid and the second, broader stripe serves as a fastener. In this way the adhesive tape is bonded to the cable in such a way that the cable harness is secured against slipping but is nevertheless of flexible design.

In addition there are embodiments of the invention in which more than one stripe of the covering is applied to the adhesive coating. When reference is made only to one stripe, the skilled person reads this, conceptually, as accommodating the possibility that two or more stripes may at the same time cover the adhesive coating.

The stripe preferably covers a total of between 50% and 80% of the adhesive coating. The degree of coverage is selected as a function of the application and of the diameter of the cable harness.

With particular preference there remain one or two adhesive stripes, whose total width accounts for 20% to 50% of the width of the backing.

Particularly if the adhesive coating is not a full-area coating but instead is, for example, in the form of a stripe or stripes, the stated percentages refer to the width of the stripes of the covering in relation to the width of the backing; in other words, in accordance with the invention, the stripe or stripes of the covering have a width which accounts for between 20% and 90% of the width of the backing.

The properties of the glass fabric of the first layer are advantageously as follows:
the basis weight is from 30 to 120 g/m², preferably from 80 to 120 g/m².
the number of filaments in longitudinal and transverse direction is in each case 1 to 10 filaments/cm, preferably in each case 3 to 10 filaments/cm; and/or
the filaments used to form the glass fabric have a linear density of less than 150 tex, preferably less than 100 tex.

According to a further advantageous embodiment of the invention the metallic layer has a thickness of 12 to 20 μm. Where appropriate it further comprises embossing. Metals which can be chosen include silver, copper, gold, platinum, aluminium and compounds of aluminium, tin, Nichrome, NIROSTA, titanium, and metal oxides such as cadmium oxides, tin oxides, zinc oxides and magnesium oxides, but preferably aluminium. This list is not regarded as being conclusive instead, the skilled person is able to choose further metal layers, not explicitly specified here, without departing from the concept of the invention.

In order to produce a self-adhesive tape from the backing it is possible to employ all known adhesive systems. Besides natural or synthetic rubber based adhesives it is possible more particularly to use silicone adhesives and also polyacrylate adhesives. Preferred on account of their particular suitability as an adhesive for wrapping tapes for automotive cable harnesses, in respect of the absence of fogging and also the outstanding compatibility with both PVC and PVC-free core insulations, are solvent-free acrylate hotmelt compositions, as described in more detail in DE 198 07 752 A1 and also DE 100 11 788 A1. The application weight is situated in the range between 20 to 100 g/m². The coating technology employed involves known systems, appropriate processes being those which permit an unpressurized placement of highly viscous adhesives—such as, for example, the coating of hotmelt adhesives via nozzle coating or via transfer from an anti-adhesive support cloth or release liner onto the backing assembly.

A suitable adhesive is one based on acrylate hotmelt with a K value of at least 20, more particularly greater than 30 (measured in each case in 1% strength solution in toluene, 25° C.), obtainable by concentrating a solution of such a composition to give a system which can be processed as a hotmelt. Concentration may take place in appropriately equipped tanks or extruders; more particularly in the case of accompanying devolatilization, a devolatilizing extruder is preferred. One such adhesive is set out in DE 43 13 008 C2. In an intermediate step, the solvent is removed completely from the acrylate compositions prepared in this way. The K value is determined more particularly in analogy to DIN 53 726.

Additionally, in the course of this process, further volatile constituents are removed. After coating from the melt, these compositions have only small residual fractions of volatile constituents. Accordingly it is possible to take on all of the monomers/formulas that are claimed in the patent cited above.

The solution of the composition may contain 5% to 80% by weight, more particularly 30% to 70% by weight, of solvent. Preference is given to using commercially customary solvents, more particularly low-boiling hydrocarbons, ketones, alcohols and/or esters. Further preference is given to using single-screw, twin-screw or multi-screw extruders having one or, more particularly, two or more devolatilizing units.

The acrylate hotmelt-based adhesive may have had benzoin derivatives incorporated into it by copolymerization: for example, benzoin acrylate or benzoin methacrylate, acrylic or methacrylic esters. Benzoin derivatives of this kind are described in EP 0 578 151 A. The acrylate hotmelt-based adhesive may be UV-crosslinked. Other types of crosslinking are also possible, however, an example being electron beam crosslinking.

In a further preferred embodiment the self-adhesive compositions employed are copolymers of (meth)acrylic acid and the esters thereof having 1 to 25 C atoms, maleic, fumaric and/or itaconic acid and/or their esters, substituted (meth)acrylamides, maleic anhydride and other vinyl compounds, such as vinyl esters, more particularly vinyl acetate, vinyl alcohols and/or vinyl ethers.

The residual solvent content ought to be below 1% by weight.

One adhesive which is found to be particularly suitable is a low molecular mass, pressure-sensitive, acrylate hotmelt adhesive of the kind carried under the name acResin UV or Acronal®, more particularly Acronal® DS 3458, by BASF. This adhesive, with a low K value, acquires its application-compatible properties through a concluding, radiation-induced crosslinking operation.

Preferably, therefore, the adhesive coating is composed of an adhesive comprising acrylate or silicone.

The adhesive may be applied in the longitudinal direction of the adhesive tape, in the form of a stripe whose width is lower than that of the adhesive tape backing. Depending on the particular utility it is also possible for two or more parallel stripes of the adhesive to be coated on the backing material. The position of the stripe on the backing is freely selectable, preference being given to an arrangement directly at one of the edges of the backing.

Suitable materials for the covering include the films that are typical more particularly for cable bandaging applications, based on polyolefins (for example polyethylene films, polypropylene films, monoaxially or biaxially oriented polypropylene films, polyester films, PA films, and other films) or PVC, preferably those with plasticizer contents between 20 and 60 phr.

As the material it is additionally possible to use all known textile backings such as a loop product, a velour, a lay, a woven or a formed-loop knit, more particularly a PET filament woven or a polyamide woven, or a nonwoven web; the term “web” embraces at least textile sheetlike structures in accordance with EN 29092 (1988) and also stitchbonded nonwovens and similar systems. It is likewise possible to use spacer fabrics, including wovens and knits, with lamination. Spacer fabrics are matlike layer structures comprising a cover layer of a fiber or filament fleece, an underlayer and individual retaining fibers or bundles of such fibers between these layers, said fibers being distributed over the area of the layer structure, being needled through the particle layer, and joining the cover layer and the underlayer to one another. The retaining fibers needled through the particle layer hold the cover layer and the underlayer at a distance from one another and are joined to the cover layer and the underlayer. Suitable nonwovens include, in particular, consolidated staple fiber webs, but also filament webs, meltblown webs and spunbonded webs, which generally require additional consolidation. Possible consolidation methods known for webs include mechanical, thermal and chemical consolidation. Whereas with mechanical consolidations the fibers are mostly held together purely mechanically, by entanglement of the individual fibers, by the interlooping of fiber bundles or by the stitching-in of additional threads, it is also possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to fiber nodal points, so that a stable, three-dimensional network is formed while the loose open structure in the web is retained.

Webs which have proven to be particularly advantageous are those consolidated in particular by overstitching with separate threads or by interlooping.

Consolidated webs of this kind are produced, for example, on stitchbonding machines of the “Malifleece” type from the company Karl Mayer, formerly Malimo, and can be obtained, inter alia, from the companies Naue Fasertechnik and Techtex GmbH. A Malifleece is characterized in that a cross-laid web is consolidated by the formation of loops from fibers of the web.

The covering used may further be a web of the Kunit or Multiknit type. A Kunit web is characterized in that it originates from the processing of a longitudinally oriented fiber web to produce a sheetlike structure which has loops on one side and, on the other, loop feet or pile fiber folds, but possesses neither threads nor prefabricated sheetlike structures. A web of this kind has been produced, inter alia, for a relatively long time, for example on stitchbonding machines of the “Kunitvlies” type from the company Karl Mayer. A further characterizing feature of this web is that, as a longitudinal-fiber web, it is able to absorb high tensile forces in the longitudinal direction. The characteristic feature of a Multiknit web relative to the Kunit web is that the web is consolidated on both the top and bottom sides by the double-sided needle punching.

Finally, stitchbonded webs are also suitable. A stitchbonded web is formed from a nonwoven material having a large number of stitches extending parallel to one another. These stitches come about through the incorporation, by stitching or knitting, of continuous textile threads. For this type of web, stitchbonding machines of the “Maliwatt” type from the company Karl Mayer, formerly Malimo, are known.

And then the Caliweb® is outstandingly suitable. The Caliweb® is composed of a thermally fixed Multiknit spacer web with two outer mesh layers and an inner pile layer, arranged perpendicular to the mesh layers.

Also particularly advantageous is a staple fiber web which is mechanically preconsolidated in the first step or is a wet-laid web laid hydrodynamically, in which between 2% and 50% of the fibers of the web are fusible fibers, more particularly between 5% and 40% of the fibers of the web. A web of this kind is characterized in that the fibers are laid wet or, for example, a staple fiber web is preconsolidated by the formation of loops from fibers of the web or by needling, stitching or air-jet or water-jet treatment. In a second step, thermofixing takes place, with the strength of the web being increased again by the melting, or partial melting, of the fusible fibers. The web backing may also be consolidated without binders, by means for example of hot embossing with structured rollers, in which case pressure, temperature, dwell time and the embossing geometry can be used to control properties such as strength, thickness, density, flexibility and the like.

Starting materials envisaged for the textile materials include more particularly polyester fibers, polypropylene fibers, viscose fibers or cotton fibers. The present invention, however, is not restricted to the stated materials; rather it is possible to use a large number of other fibers to produce the material, this being evident to the skilled person without any need for inventive activity. Use is made more particularly of wear-resistant polymers such as polyesters, polyolefins, polyamides or fibers of glass or of carbon.

Also suitable as materials are laminates formed from films or from foam materials in web form (made of polyethylene and polyurethane, for example).

Through a suitable selection of the material it is possible to vary the jacketing formed with the adhesive tape within wide ranges. For instance, abrasion resistances and temperature resistances, damping properties, and also color and appearance of the covering can be chosen.

Furthermore, the first layer, the stripes of the covering and/or the adhesive coating may have been made flame retardant by means, for example, of a flame retardant composed of ammonium polyphosphate, magnesium hydroxide and/or aluminium hydroxide or by means of a chlorinated paraffin, where appropriate in combination with antimony trioxide. The flame retardants may also be organobromine compounds, if required with synergists such as antimony trioxide, but in view of the freedom from halogen of the adhesive tape, red phosphorus, organophosphorus, mineral or intumescent compounds such as ammonium polyphosphate alone or in combination with synergists are preferably used.

The adhesive tape may preferably have an abrasion resistance to ISO 6722 on single-ply measurement such as to withstand a number of strokes of more than 500, more particularly of 800 to 2500.

The adhesive tape may then exhibit sound damping to BMW GS 95008-3 on single-ply measurement of more than 3 dB (A), more particularly 5 dB (A) to 6 dB (A).

The adhesive tape is preferably hand-tearable at least in the transverse direction. In order to optimize the dispensing of the adhesive tape, in one preferred embodiment of the invention there are weakening lines which extend over the entire width of the adhesive tape. In order particularly to simplify operation for the user, the weakening lines are aligned at right angles to the running direction of the adhesive tape and/or are disposed at regular intervals. A further improvement in the use of the adhesive tape can be achieved if the adhesive tape is severed completely, preferably at regular intervals, and applied in the form of what are called “kiss-cut diecuts” to release paper. In this way the individual diecuts can be dispensed selectively through use of a dispenser. Preferably the weakening lines are configured in the form of perforations. In this way it is possible to obtain edges between the individual sections that are highly lint-free, thus preventing unwanted fraying.

The weakening lines can be produced in a particularly advantageous way either discontinuously, using flat dies or cross-running perforating wheels, or continuously, using rotary systems such as spiked rollers or punch rollers, with or without the use of a counter-roller (Vulkollan roller), forming the counterwheel during cutting. Further possibilities include cutting technologies which are controlled to operate intermittently, such as the use of lasers, ultrasound, high pressure water jets, for example. Where, in the case of laser or ultrasound cutting, some of the energy is introduced into the material in the form of heat, it is possible to melt the material in the area of cutting, thereby very largely preventing disruptive fraying, and giving sharply contoured cut edges. Latter methods are also suitable for obtaining specific cut edge geometries, such as concave or convex cut edges, for example. The height of the spikes or blades on the punch rollers is preferably 150% of the thickness of the adhesive tape. The hole/bridge ratio in the case of perforation—that is, the ratio of the number of millimeters where the material is held together (“bridge”) to the number of millimeters over which it is severed—determines how easy the adhesive tape is to tear. Furthermore, this ratio also ultimately influences the extent to which the torn edge is lint-free. The bridge width is preferably approximately 2 mm and the cut width between the bridges is preferably approximately 5 mm: in other words, bridges 2 mm wide alternate with incisions 5 mm long. The hole/bridge ratio, accordingly, is preferably 2:5. With this weakening of the material it is possible to achieve a sufficiently low tearing force.

The adhesive tape is preferably used for jacketing elongate material such as, more particularly, cable harnesses, the elongate material being wrapped in the axial direction by the adhesive tape, or the adhesive tape being guided in a helical spiral around the elongate material.

Also embraced by the concept of the invention, finally, is an elongate material, such as, more particularly, a cable harness, jacketed with the adhesive tape of the invention.

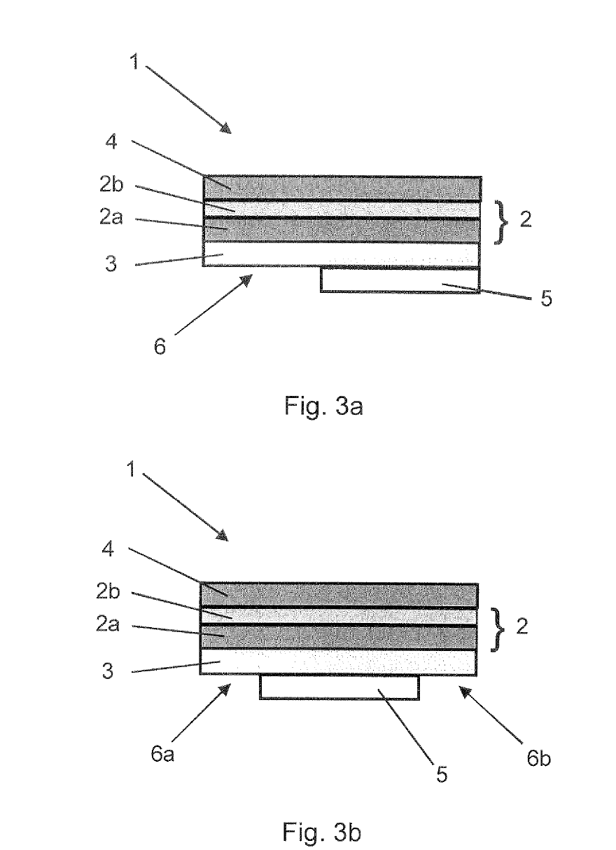

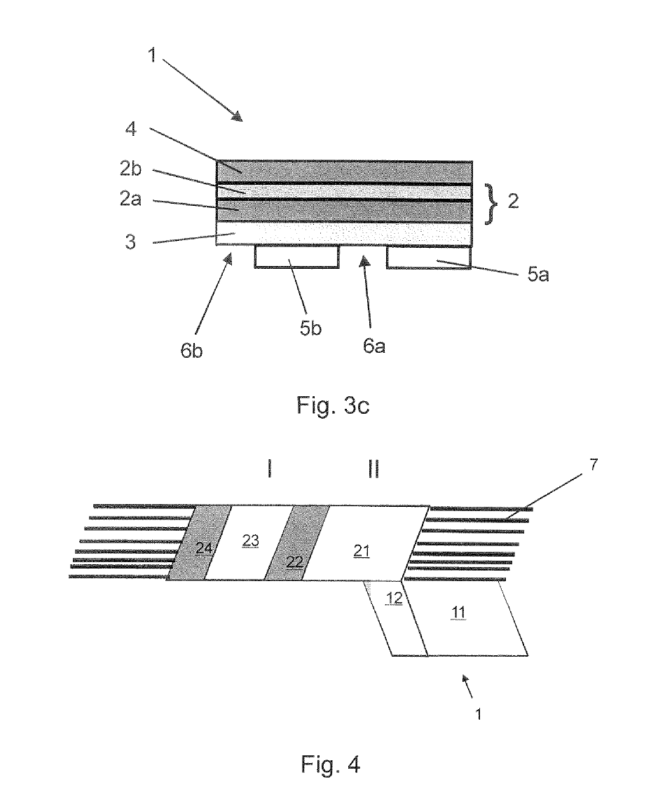

With reference to the FIGS. 3a, 3b, 3c and 4, the adhesive tape of the invention is elucidated in more detail in one particularly advantageous embodiment, without wishing thereby to restrict the invention.

In accordance with FIG. 3a a heat-reflecting adhesive tape (1) of the invention comprises a tapelike backing (2) which is composed of an assembly of at least one first layer (2a), formed by a glass fabric having a basis weight of 30 to 200 g/m², and at least one second layer (2b), formed by a metallic layer having a thickness of 10 to 40 μm and a thermal effectiveness to SAE J2302 at 350° C. of greater than 45° C.

Applied on one side of the backing (2) is a pressure-sensitive adhesive coating (3).

Applied to the open side, opposite the first layer (2a), of the second layer (2b) is a siliconization (4).

On the adhesive coating (3) there is precisely one stripe (5) of the covering, in such a way that the stripe (5) lies directly at one of the longitudinal edges of the backing (2). This produces an adhesive stripe (6) which extends in the longitudinal direction of the adhesive tape (1).

In FIG. 3b the stripe (5) is applied centrally on the adhesive coating (3), thus producing two adhesive stripes (6a, 6b) extending at the edges of the backing (2) in the longitudinal direction of the adhesive tape (1).

In FIG. 3c two stripes (5a, 5b) are applied on the adhesive coating (3), thus producing two adhesive stripes (6a, 6b) extending at the edges of the backing (2) in the longitudinal direction of the adhesive tape (1).

FIG. 4 shows a section of a cable loom which is composed of a bundle of individual cables (7) and which is jacketed with the adhesive tape (1) of the invention. The adhesive tape (1) is guided in a spiral motion around the cable loom.

The section of the cable loom that is shown has two winds 1 and 11 of the adhesive tape (1). Further winds would extend towards the left; these are not shown here.

A stripe (5) of the covering is present on the adhesive coating (3), so that nonadhesive areas (11, 21, 23) of the adhesive tape alternate with adhesive areas (12, 22, 24). (In contrast to the exposed adhesive 12, the sections 22 and 24 are not visible from the outside, which is why the denser shading has been selected to depict them.)

The cable loom is jacketed in such a way that the adhesive stripe (6) adheres fully to the adhesive tape (1). Sticking to the cables (7) is not possible.

The object of the invention is to provide a thermally insulating jacket with low production cost and complexity and with low installation costs, and hence to provide a simple presentation form which protects the lead insulation, whose temperature resistance is low, in a cable harness through the partial use of jacketing, especially in regions of relatively high temperatures, while meeting the requirements (as called for, for example, in the automotive testing guideline LV 312) and which at the same time meets the requirements for enhanced abrasion protection.

This object must be considered to have been achieved.

The stripe or stripes of the covering on the adhesive coating produce a nonadhesive region and, furthermore, add further functions which in a number of respects are beneficial to the properties of the wrapped cable harness.

Particularly advantageous is the effect on abrasion resistance of the jacketing of the invention, which is not adhesive over its full area. The requirements of OEM specifications such as LV 312 are met.

Particularly advantageous is the effect on sound damping of the jacketing of the invention, which is not adhesive over its full area. The requirements of OEM specifications such as LV 312 are met.

Particularly advantageous is the effect on cable harness flexibility of the jacketing of the invention, which is not adhesive over its full area. The requirements of OEM specifications such as the 19 Dec. 2001 Fiat Auto Normazione Procurement Specification 9.91220, section 2.4.1: Flexibility test, can be met in a particularly advantageous way.

The invention then meets the requirement for long-term service temperatures of, for example, 200° C. (class F) in accordance with SAE J 2192 or other specifications.

Surprisingly, and unexpectedly to a person skilled in the art, the adhesive tape of the invention further displays the feature, in spite of the very much thinner metal layer as compared with the known tapes, of providing outstanding heat reflection. At the same time the thin metal layer is also responsible for the adhesive tape leading to far more flexible products when they are jacketed with the adhesive tape.

This is also shown by the following comparative measurements.

The adhesive tapes described below consist of the layers set out one after the other (second layer, first layer, full-area adhesive coating on the first layer).

The following materials were investigated:

### COMPARATIVE EXAMPLE 1

17 μm aluminium foil, 100 g/m² glass fabric, 90 g/m² pressure-sensitive acrylate adhesive (acrylate PSA)

### INVENTIVE EXAMPLE 2

17 μm aluminium foil, 100 g/m² glass fabric, 90 g/m² acrylate PSA, 130 g/m² PET cloth as a stripe on the adhesive coating, the stripe disposed on the longitudinal edge covering 66% of the adhesive coating

### INVENTIVE EXAMPLE 3

17 g/m aluminium foil, 100 g/m² glass fabric, go g/m² acrylate PSA, 200 g/m² Malifleece as a stripe on the adhesive coating, the stripe disposed on the longitudinal edge covering 66% of the adhesive coating

### INVENTIVE EXAMPLE 4

17 μm aluminium foil, 100 g/m² glass fabric, 90 g/m² acrylate PSA, 180 g/m² Maliwatt as a stripe on the adhesive coating, the stripe disposed on the longitudinal edge covering 66% of the adhesive coating

### COMPARATIVE EXAMPLE 5

30 μm aluminium foil with 300 g/m² glass fabric, go g/m² acrylate

### Results

Abrasion resistance according to LV 312:

The abrasion resistance of the adhesive tape can be improved significantly in all cases by laminating-in the stripe:

TABLE 1
Abrasion resistance

| | Abrasion |
|---|---|
| Specimen | strokes |
| Comparative Example 1 | 24 |
| Inventive Example 2 | 1200 |
| Inventive Example 3 | 2300 |
| Inventive Example 4 | 1100 |
| Comparative Example 5 | 100 |

### Sound Damping (BMW GS95008-3)

The damping properties of the adhesive tape can be improved significantly in each individual case by the laminating-in of the stripe:

TABLE 2
Sound damping

| | Damping |
|---|---|
| Specimen | dB(A) |
| Comparative Example 1 | 4.2 |
| Inventive Example 2 | 5.6 |
| Inventive Example 3 | 3 |
| Inventive Example 4 | 13.9 |
| Comparative Example 5 | 8.9 |

### Flexural Rigidity

The flexural rigidity is a measure of the flexibility of a backing or of a backing assembly. The values set out in Table 3 show that through the laminating-on of a stripe of different textile materials the flexural rigidity is increased within an acceptable framework. The specimen “Inventive Example 3” experiences virtually no change in flexibility, but has an abrasion resistance of approximately 1200 strokes (Table 1). The flexural rigidities were measured using a Softometer KWS basic 2000 mN from Wolf.

TABLE 3
Flexural rigidities

| | FR longitudinal | FR transverse |
|---|---|---|
| Specimen | mN | mN |
| Comparative | 229 | 148 |
| Example 1 | | |
| Inventive Example 2 | 260 | 180 |
| Inventive Example 3 | 450 | 340 |
| Inventive Example 4 | 300 | 200 |
| Comparative | 558 | 352 |
| Example 5 | | |

What is claimed is:

1. Heat-reflecting adhesive tape comprising a tapelike backing comprising an assembly comprising at least one first layer, said first layer formed by a glass fabric having a basis weight of 30 to 200 g/m², and at least one second layer, said second layer formed by a metallic layer having a thickness of 10 to 40 μm and a thermal effectiveness to SAE J2302 at 350° C. of greater than 45° C., having a pressure-sensitive adhesive coating applied at least to one side of the backing, and at least one stripe of a covering which is provided on a free side of the adhesive coating and which extend(s) in a longitudinal direction of the adhesive tape and which cover(s) between 20% and 90% of the adhesive coating.

2. Heat-reflecting adhesive tape according to claim 1, wherein the adhesive coating is applied to an open side, opposite the second layer, of the first layer.

3. Heat-reflecting adhesive tape according to claim 1, which is siliconized on an open side, opposite the first layer, of the second layer.

4. Heat-reflecting adhesive tape according to claim 1, which exhibits a flexural rigidity in a longitudinal and transverse direction of less than 500 mN as measured with a Softometer KWS basic 2000 mN from Wolf.

5. Heat-reflecting adhesive tape according to claim 1, wherein the glass fabric of the first layer exhibits the following properties:
a basis weight of 80 to 120 g/m²;
3 to 10 filaments/cm in the longitudinal and transverse directions;
and/or
filaments having a linear density of less than 150 tex.

6. Heat-reflecting adhesive tape according to claim 1, wherein the metallic layer has a thickness of 12 to 20 μm.

7. Heat-reflecting adhesive tape according to claim 1, wherein the metallic layer is composed of aluminium.

8. Heat-reflecting adhesive tape according to claim 1, wherein the adhesive coating is composed of an adhesive comprising acrylate or silicone.

9. Heat-reflecting adhesive tape according to claim 1, which comprises only one stripe of the covering on the adhesive coating.

10. Heat-reflecting adhesive tape according to claim 1, wherein the stripe of the covering is applied on the adhesive coating in such a way that an outer edge of the stripe is congruent with an outer edge of the backing or in such a way that the stripe is applied centrally on the adhesive coating.

11. Heat-reflecting adhesive tape according to claim 1, wherein at least one of the first layer, the stripe of the covering and the adhesive coating is flame retardant.

12. Heat-reflecting adhesive tape according to claim 1, which exhibits an abrasion resistance to ISO 6722 on single-ply measurement such as to withstand a number of strokes of more than 500.

13. Heat-reflecting adhesive tape according to claim 1, which exhibits sound damping to BMW GS 95008-3 on single-ply measurement of more than 3 dB (A).

14. A method for jacketing elongate material comprising wrapping the elongate material in an axial direction with an adhesive tape adhesive tape according to claim 1, or guiding the adhesive tape in a helical spiral around the elongate material.

15. Method according to claim 14, wherein the elongate material is a cable harness.

16. Elongate material jacketed with an adhesive tape according to claim 1.

17. Elongate material according to claim 16, which is a cable harness.
